(19) United States
(12) Patent Application Publication
(10) Pub. No.: US 2004/0103023 A1
(43) Pub. Date: May 27, 2004

(54) Coupon barcode internet verification system

(76) Inventors: John R. Irwin, Meyersville, NJ (US); Lawrence F. Fox, Branchburg, NJ (US); Joan Wyndrum O'Hear, Avon, NJ (US)

Correspondence Address: WARD & OLIVO, 382 SPRINGFIELD AVENUE, SUMMIT, NJ, 07901, US

(21) Appl. No.: 10/302,504

(22) Filed: Nov. 25, 2002

(51) Int. Cl. G06F 17/60

(52) U.S. Cl. 705/14

(57) ABSTRACT

An interactive Internet-based Coupon Barcode Verification system comprises a central computer system connected to the Internet. The system is adapted to be accessed by one or more authorized personal computers. A browser and keyboard, and optionally a barcode reader, constitute the minimal hardware and software required to verify the validity of barcode data. The barcode data can be transmitted over the Internet to the coupon barcode verification system by means of the keyboard. Alternatively, the barcode reader and the web browser transmits the information. An algorithm logic means analyzes the barcode data provided by the authorized personal computers to determine the validity of the barcode data. The validity determination is based on UCC guidelines, recognized MIN, Family Code, Value Code and EAN-128 Extended Codes. Advantageously, the system enables manufactures to issue coupons having valid barcodes. Coupon clearinghouses can view coupon graphics before issuance, and retailers can identify and document barcode errors. Fines based on coupon defects are virtually eliminated. The system facilitates coupon classification and facilitates validation by providing a validation or a failure report.

### BACKGROUND OF THE INVENTION

1. Field of the Invention

The present invention relates to document verification systems; and more particularly to an Internet based coupon verification system for determining the validity of the barcode printed on a coupon.

2. Description Of The Prior Art

Coupon barcodes contain the coupon's offer information, including its value, purchase requirements, issuer (typically a manufacturer), and possibly expiration and offer coding data. Coupon barcodes are conventionally verified when a coupon is redeemed at a store during purchase of a product. The cashier verifies any printed expiration date and matches the product purchased against the requirement stated on the coupon. In many cases, the point-of-sale system (POS) reads the barcode of the coupon and performs the necessary validation electronically to provide credit to the customer. Retailers collect redeemed coupons and submit them to the manufacturers for direct payment, or to coupon clearinghouses, who submit the coupons to manufacturers for payment on behalf of the retailer. If the coupon barcode is unreadable by POS scanners due to production errors, or if any of the barcoded elements in a readable barcode are incorrect, the retailer and/or the clearinghouses may levy fines on the issuer of the coupon. These conventional aspects of the coupon redemption process are described in greater detail hereinafter.

U.S. Pat. No. 4,949,256 to Humble, discloses a coupon verification and redeeming system wherein a central control system is connected to many local control stations at numerous retailers using dedicated lines. All participating manufacturer's coupons are loaded into the central control system, and a copy of it is updated in each and every local control station. When a customer coupon is scanned, it is checked against the list of manufacture's coupons to validate and process the redemption. Thereafter, the coupon is maintained in a second file in the local control station. Such a process requires back and forth communication between the central and local control station. It uses dedicated lines and is not an Internet based coupon validation and verification system. The process does not check for the validity of the coupon, or its ability to be processed at the coupon clearinghouse.

U.S. Pat. No. 5,208,445 to Nahar et al. discloses a method and apparatus for receiving, marking and retaining discount coupons. A coupon acceptor draws in and accumulates discount coupons, which are used. The coupons are marked so that they cannot be reused. A mechanical device with rollers captures and accumulates the coupons, and marks them to prevent reuse. The apparatus does not determine validity of a coupon's barcode so to facilitate proper handling by a coupon clearinghouse.

U.S. Pat. No. 5,245,533 to Marshal discloses a marketing research method and system for management of a manufacturer's discount coupon offers. This system collects from coupon redemption data and coupon release data to create a correlated template indicating customer use of coupons. This data is provided to the manufacturers to optimize their discount coupon offering processes.

U.S. Pat. No. 5,581,064 to Riley et al. discloses an automated coupon processing system wherein a coupon is provided with an identifying code and a preselected second identifying code that uniquely identifies the coupon. A barcode reader identifies the codes and detects whether the code is UCC to determine the presence of the coupon. Detection of the first codes identifies the manufacturer and the family codes. If a second set of codes is detected, the system verifies the coupon's expiration date and whether the coupon is a different release from the same manufacturer with a different promotional code. If a different second code is detected, the system prompts the user to enter the expiration code for the promotion code, and to enter the new coupon into the data stored by the verification system. This entry allows the coupon data to be stored in the database as a new valid coupon. The barcode is not verified if it meets UCC guidelines before being entered into the database as a valid coupon barcode.

U.S. Pat. No. 5,612,527 to Ovadia discloses a discount offer redemption system and method. The flyer has identifying indicia or card, which the user takes to the store for product purchases. The system verifies whether products are discounted and provides appropriate credit. It also collects user's information, including post office address and the like, to maintain a database of product usage preferences.

U.S. Pat. No. 5,905,246 to Fajkowski discloses a method and apparatus for coupon management. An electronic card with a microprocessor and random access memory is used to scan barcode data from many coupons and receive information from a peripheral device on terms and conditions of coupon redemption. The user inserts the electronic coupon card to the register at the point of sale. Coupon information and terms of redemption are assessed from the card by the check out system.

U.S. Pat. No. 6,230,143 to Simons et al. discloses a system and method for analyzing coupon redemption data. A special two dimensional barcode embeds information about the user and the product to track and analyze customer coupon preferences. This information is used by manufacturers to target promotional dollars on various promotional elements in rapid response to the preferences of coupon users.

U.S. Pat. No. 6,328,339 B2 to Dixon, Ill. et al. discloses a system, method and apparatus for coupon processing and booklet. A front end of the system scans and collects coupons while a central microprocessor and a back end receives the scanned barcode data and the coupons. The central processor validates the manufacturer, family code, value and expiration date of a coupon and collects data of valid coupons for electronic redemption from the manufacturer. Valid coupons are sorted and destroyed. Invalid coupons are stored in a separate storage bin. Working at the retail end, the system separates coupons presented by the customer into valid and invalid coupon categories. Invalid coupons and are further processed for electronic collection or invalid coupon storage. The system can also accept a single barcode assigned by the retailer to provide store discounts for a number of items. Criteria used for validation include the UCC code for the coupon, the manufacturer's UCC MIN# code, the family code, the value code and the check digit. No use is made of other codes, other than the expiration code embedded in the UCC Min# code; the system does not check for the proper structure of the family code.

U.S. Pat. No. 6,336,098 B1 to Fortenberry et al. discloses a method for electronic distribution and redemption of coupons on the worldwide web. A centralized computer system creates e-coupons based on the request from a retailer or manufacturer with terms and conditions. The e-coupon file is transmitted electronically to user's computers and a computer file is stored thereon. When a customer conducts e-commerce purchase, the e-coupon is transmitted to a redemption web site for processing. The purchase of the required item is verified by inventory reduction and the like.

U.S. Pat. RE. 34,915 to Nichtberger et al. discloses a paperless system for distributing, redeeming and clearing merchandise coupons. The system uses an electronic display in a retail store, or is accessed from home. A customer selects coupons from the list and is provided with an identifier, specific to a customer. During check out, items purchased are correlated against a selected list of coupons and credits are issued. Alternatively, customers are provided with an identifier card, which keeps track of the customer during coupon selection and check out procedures. The system generates coupons, distributes them electronically and collects them electronically without using paper or barcodes.

U.S. Pat. RE. 37,166 E to Rando et al. discloses a scanner with coupon validation. A point of sale scanning system, which normally detects barcodes of products during check out, is used to scan coupons. In one embodiment, the laser beam which scans products during purchase also scans the coupons. In another embodiment, two laser beams are used; one to scan the product purchased and the other to scan the coupons. The coupon decoding software detects UPC manufacture number, family code and the face value embedded in the barcode. Products previously presented for purchase are compared against the coupon to issue credit without performing a complete check on the validity of the coupon. The coupons are then collected in a secure system to prevent double redemption and misuse.

US Patent Application No. 2001/0018664 A1 to Jacoves et al. discloses a method for processing information through a clearinghouse. A rewards provider assembles information on fuel rewards. The assembled information is transmitted to a store chain central office, which distributes the information electronically to individual stores. Discount fuel coupons are issued electronically or as printed coupons during customer purchase of products meeting the rewards program. When a customer purchases fuel at the gas station using the electronic coupons or printed coupons, information is provided to a clearinghouse, which submits bills to the manufacturer for the cost of promotion program. A cooperative program thereby created between a rewards provider, store chain central office and individual stores provides fuel rewards to customers that purchase promotional products. The customer cashes in on the electronic or printed coupons at the gas station and the coupons are provided to a central clearinghouse, which bills the manufacturers.

US Patent Application No. 2001/0032130 A1 to Gabos et al discloses a marketing information system for remote computing platforms. A hand held computer is used to generate a shopping list, which is communicated to the closed loop marketing system computer at the retail store. The shopping list is compared with previous frequent purchases to suggest products, which may have been forgotten from the customer's shopping list and to suggest special promotions. The hand held unit may scan barcodes as items are purchased. At check out the final bill is transmitted to the hand held computer unit accounting for promotions, whereupon the store closed loop computer data on user profile is updated.

US Patent Application No. 2001/0037236 A1 to Dixon, Ill. et al. discloses a system, method and apparatus for coupon processing. The system comprises a front end, which scans and collects coupons. A central microprocessor and a back end receive the scanned barcode data and coupons. The central processor validates the manufacturer, family code, value and expiration date of a coupon and collects data of valid coupons for electronic redemption from the manufacturer. Valid coupons are sorted and destroyed. Invalid coupons are stored in a separate storage bin. The systems operates at the retail stage, sorting coupons presented by the customer into valid and invalid coupon categories, and treating them accordingly for electronic collection or invalid coupon storage. The system can also accept a single barcode assigned by the retailer to provide store discounts for a number of items. Coupon validating criteria comprise the coupon's UCC code, the manufacturer's UCC MIN# code, the family code, the value code and the check digit. Additional codes, other than the expiration code embedded in the UCC MIN# code are not utilized, and there is no check involving the proper structure of the family code.

US Patent Application No. 2001/0054003 A1 to Chien et al. discloses a system and method for using loyalty points. This system keeps track of loyalty points and provides merchandise credit or cash credit for purchases conducted over a computerized network with credit card transactions. Loyalty points are deducted when credit is issued. The system provides loyalty points and issues credits over a wide range of purchases, using different vendors. No check is made concerning the accuracy of the coupon barcode. The system does not create a validation or a failure report.

US Patent Application No. 2002/0033597 A1 to Dixon, Ill. et al. discloses a system, method and apparatus for coupon processing. The system uses a front end to scan and collect coupons. A central microprocessor and a back end receives the scanned barcode data and coupons. The central microprocessor validates the manufacturer, family code and the value and expiration date of a coupon. Data of valid coupons is collected for electronic redemption from the manufacturer. Valid coupons are sorted and destroyed. Invalid coupons are stored in a separate storage bin. The system works at the retail end processing coupons presented by the customer into valid coupons and invalid coupons, which are treated accordingly for electronic collection or invalid coupon storage. It can also accept a single barcode assigned by the retailer to provide store discounts for a number of items. The criteria used for validating a coupon are the UCC code for the coupon, the manufacturer's UCC MIN# code, the family code, the value code and the check digit. No attention is paid to other codes, other than using the expiration code embedded in the second code. The system does not check for the proper structure of the family code. Moreover, the system does not check the complete accuracy of the coupon barcode and create a validation or a failure report.

US Patent Application No. 2002/0040321 A1 to Nicholson discloses a method for cross-marketing, utilizing electronic coupons. The method uses at least one cross-marketed product to issue a gasoline price per unit discount coupon, which reduces the price per gallon of fuel purchased. When a second cross-marketed product is purchased, the first discount is added to the second discount to arrive at a new price per unit discount for gasoline purchase. The gas station computer provides the price per unit discounts, and bills the cross-marketed product manufacturers. No check is made concerning the complete accuracy of the coupon barcode. The system does not create a validation or a failure report.

Foreign Patent No. WO 95/30199 to Granger discloses a method and apparatus for electronically clearing and processing bar-coded discount coupons. In this method, the coupon is scanned at retail locations and the information of product purchase and scanned coupon barcode is transmitted electronically to an independent computerized coupon-processing center. The original coupons are collected and sent to a different location, where a random portion of the collected coupons is verified against the data stored in the computerized coupon-processing center. Purchase data is linked against coupon usage—a feature not present with conventional paper coupon processing procedures. Paper coupon counting of a small fraction of coupons presented is used for auditing purposes. The electronic system validates coupon usage against purchases and stores purchase data together with coupon usage in an independent central computerized facility, which sends bills to manufacturers according to coupon usage. No check is made concerning the complete accuracy of the coupon barcode. The system does not create a validation or a failure report.

The web-site at http://www.poscentral.com/lpos.html describes the L-POS system. A front end of the system is used for loyalty programs including in store coupon generation, coupon multiplication, special customer pricing, price comparisons and points tracking. The system accepts UPC/PLU codes and is compatible with standard interchange language. It operates on a windows based PC environment. This retail customer coupon generation and processing system does not handle standard printed coupons. It relies instead upon locally generated electronic coupons. The system does not check the complete accuracy of the coupon barcode; it does not create a validation or a failure report.

“The Complete Grocery POS Solution” detailed at http://www.datasym.com/HiRez/Products/Brochures/Files/6KGRBRO.PDF” discloses a grocery point of sale system suitable for grocery stores with 1 to 7 lanes. Each cashier has a 6000GR terminal which is compatible with standard interchange language. The system processes purchases, scans coupons and validates coupon usage and processes purchase. It provides no check concerning the complete accuracy of the coupon barcode, and does not create a validation or a failure report.

Coupons are routinely printed and distributed to customers to provide them an incentive to purchase specific products which are promoted, and to maintain brand loyalty. Coupons are designed by manufacturers or their agents according to promotional requirements. The barcodes printed must meet UCC requirements, and must be correctly coded with all the specified elements, including Number System Character, Manufacturer Identification Number (MIN), Family Code, Value Code, Check Digit and the appropriate EAN-128 Coupon Extended Code to assure that they are handled properly by POS systems and coupon clearinghouses. Any error in the coupon barcode impairs coupon processing by the retailers and clearinghouses and results in fines for the manufacturer who issued the coupons. Coupon clearinghouses would like to review the graphics of coupons before they are issued, and would like to have processes in place to receive and categorize these coupons. Retailers would like to document poorly barcoded coupons for auditing purposes. Conventional systems neither provide this functionality, nor verify the validity of the barcode printed on a coupon. There remains a need in the art for a system that has these attributes, and which can be readily accessed over the Internet to validate a particular coupon.

### SUMMARY OF THE INVENTION

The present invention provides an interactive Internet-based Coupon Barcode Verification system that reviews the barcoded elements of coupons before they are issued. Coupons are scanned via the Website interface, and their content is verified, stored and categorized. Inaccurately barcoded coupons are documented for auditing purposes. Barcode errors are detected before issuance, coupon processing is facilitated, fines based on improper issuance of defective coupons are avoided, and misredemption is reduced.

Generally stated, the system comprises a central computer system connected to the Internet. The central computer system is adapted to be accessed by one or more authorized personal computers. Minimal hardware and software is required for access. Typically, these requirements are comprised of a PC with Internet access, web browser software, and a barcode reader. Barcode data is transmitted over the Internet to the coupon barcode verification system by means of the keyboard or a barcode reader and the web browser. The central computer system additionally comprises algorithm logic means for analyzing barcode data from the authorized personal computers to determine its validity. Validity determinations are based on preselected criteria, including UCC guidelines, recognized MIN, Family Codes, Value Codes, Check Digits, and EAN-128 Extended Codes. The central computer has an actively managed database comprised of coupon barcode data, coupon images, published POS data used by retailers, and current UCC value codes and manufacturer IDs. Any authorized personal computer user meeting minimal hardware and software requirements can utilize the system to verify the readability and content of a coupon barcode and obtain a coupon verification acceptance certificate, or obtain a coupon verification failure report. Both the verification acceptance certificate and the coupon verification failure report visibly display the decoded coupon barcode data. The authorized user may generate an attachment to the verification acceptance certificate to document the specific products that will be redeemable for the scanned coupon (“product list”). Optionally, the authorized user may elect to submit a graphic image of the coupon via the website interface. If a coupon image is submitted, both the verification acceptance certificate and the coupon verification failure report will include the display of the submitted image in the form of an attachment to the certificate or report (“coupon image”). Optionally, the authorized user may elect to enter additional offer data via the website interface, including redemption estimates, redemption policies and distribution information (“offer details”). If offer details are entered, both the verification acceptance certificate and the coupon verification failure report will include the display of the offer details within the certificate or report. Coupons can be verified for barcode data accuracy prior to production and distribution, and images of the coupons can be stored in the system. Once the coupon barcode is scanned, the coupon barcode verification system delivers coupon content information to one or more authorized personal computer users. The coupon content information includes decoded barcode data as well as any coupon image or offer detail information that may have been submitted with it. Authorized manufacturer or coupon issuer users and their agents can access appropriate coupon records via the Internet to monitor coupon production and distribution. Authorized coupon clearinghouses can access the coupon barcode verification system over the Internet to preview upcoming coupons, thereby streamlining their coupon processing operations. Retailers can access the coupon barcode verification system to scan and document poorly produced or poorly barcoded coupons for auditing purposes.

### BRIEF DESCRIPTION OF DRAWINGS

The invention will be more fully understood and further advantages will become apparent when reference is had to the following detailed description and the accompanying drawings, in which:

FIG. 1 is a block diagram illustrating functional components of a coupon barcode verification system in accordance with the present invention, block B depicting procedures and steps used to identify the validity of the coupon barcode;

FIG. 2 is a block diagram illustrating functional components of the coupon checking logic block B of FIG. 1, designated phase 1 of coupon verification logic, and showing a procedure wherein the coupon is checked for first digit(s) 5 or 99 indicating a coupon (step 1), check digit verified (step 2), EAN-128 code format verified (step 3) and processed according to EAN-128 code format, so that if EAN-128 code format is 2 or 4, then expiration date code format is verified (step 4), and if the date code is greater than one year, an error is generated (step 5);

FIG. 3 is a block diagram illustrating functional components of the coupon checking logic block B of FIG. 1, designated phase 2 of coupon verification logic, in which the logic pipelines ‘B’, ‘C’, ‘D’ and ‘E’ from FIG. 2 are continued, the logic path ‘C’ of barcode verification is continued for expiration date before current date to indicate that coupon has expired (step 6), the company's MIN# prefix is verified against Uniform Code Council (UCC) data (step 7), a check is made to determine whether this MIN# of the company is registered with the UCC (step 8), If the user's account is associated with the MIN# being used (step 9), if there are products associated with the MIN# in current POS data (step 10), if the family code used is reserved (step 11A), and if the universal family code has been used (step 11B);

FIG. 4 is a block diagram illustrating the functional components of the coupon checking logic block B of FIG. 1 called phase 3 of coupon verification logic. The logic pipelines ‘F’, ‘G’ and ‘E’ from FIG. 3 are continued. The logic path ‘F’ and ‘G’ come together to validate the family code. The family code is checked to see if it is a Summary Code (step 11c), a family code without a super summary code (step 11d), a family code with no summary code (step 11e), a Super Summary Code (step 11f), or that the 992 Bypass Family Code is being used (step 11g). Finally, the Valid Product Count and list is complied from current retail POS data using the Family Code and UCC Company Prefix (MIN). If one or more products are found, logic proceeds along pipeline ‘H’ and if none are found, logic proceeds along pipeline ‘I’;

FIG. 5 is a block diagram illustrating the functional components of the coupon checking logic block B of FIG. 1 called phase 4 of coupon verification logic. The logic pipelines ‘H’, ‘I’ and ‘E’ from FIG. 4 are continued. The logic path ‘H’ and ‘I’ come together to identify products with unregistered family codes in POS data (step 13), and products that have family codes in a transition state are identified (step 14). Next, a search for the description of the family code used is performed in a table provided by the manufacturer (step 15). Step 16 validates the value code against current UCC guidelines. Step 17 validates the family Code 992 usage. Step 18 searches the history of stored data for identical scans on file and step 19 searches history for identical offers on file. This completes the logic verification of block B in FIG. 1 and exits as logic pipeline ‘J’ for printing coupon acceptance report or coupon failure report as shown in FIG. 1;

FIG. 6 is a printout of a Coupon Verification Report explaining details of each of the elements in the report. This verification report is countersigned by approving manager to create an audit report;

FIG. 7 is a printout of a Coupon Product List generated by the system. This provides a list of current redeemable products for the coupon using current POS retail data and can be printed out as shown in FIG. 1;

FIG. 8 is a printout of a Coupon Image for an acceptable coupon printed by the system indicating the graphics of the coupon along with the description of the elements of the barcode and optional user-entered offer details;

FIG. 9 is a printout of a Coupon Failure Report generated by the system indicating the reasons for failure of the barcode to pass verification tests and suggests methods to fix the errors. The failure report cannot be countersigned with an approval signature since the coupon is defective; and

FIG. 10 is a printout of a Coupon Image for a failed coupon wherein the verification tests generates errors or warnings.

### DESCRIPTION OF THE PREFERRED EMBODIMENTS

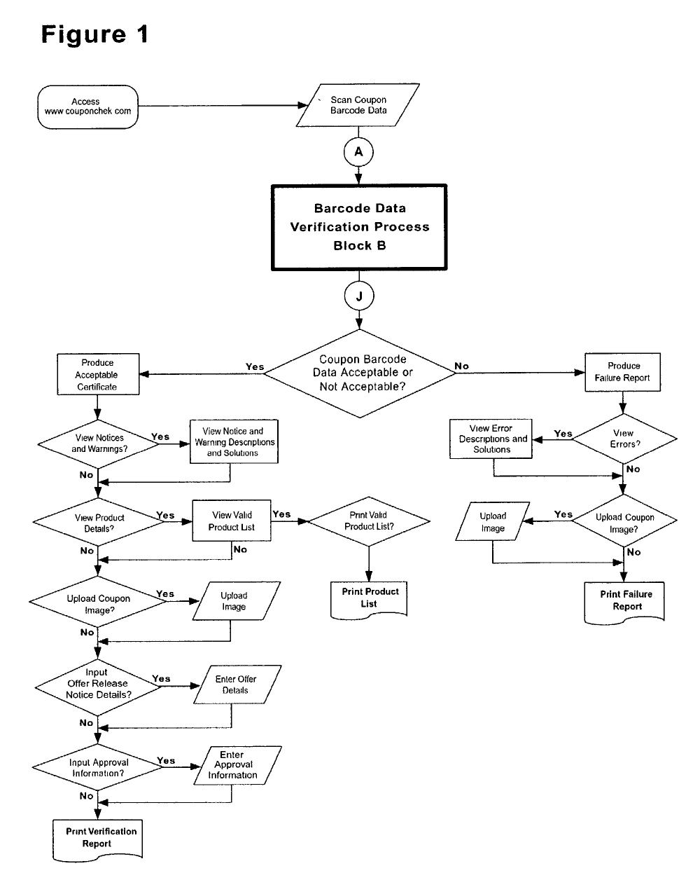

The CouponChek™ System is web based. It uses the Internet to connect users with a centralized computer system, which maintains several levels of functionality. These include 1) coupon verification system 2) family code manager and 3) product data dispatcher. The coupon verification system helps to reduce or eliminate tens of thousands of dollars in unintended redemptions and retailer fines caused by incorrectly produced coupons. It verifies point of sale (POS) readability of the coupon barcode, verifies content and format against UCC guidelines, generates a verification report confirming scan results, and consolidates offer history for tracking and reporting. The coupon verification system decodes coupon barcodes and validates several key features thereof, so that retailers and clearinghouses can accurately process the coupons. Coupon barcode errors, if not detected prior to issuance, cause manufactures to incur fines when defective coupons are processed through retailer and clearinghouse operations. A schematic diagram of an algorithm used to verify coupons based on barcodes is shown in FIGS. 1 through 5. The family code manager is an online application that allows authorized manufacturer users to maintain, correct and communicate their internal family code structures for accurate promotions coding. When a family code list is loaded into the Internet-based family code manager system, the system displays the family code data in an easy-to-read hierarchical text structure, links all current point-of-sale products to their appropriate family codes, lists any products with unmatched family codes, and highlights family code usage that conflicts with UCC guidelines. The product data dispatcher offers users a one-step maintenance and distribution tool for product promotion data. This single entry process allows users to review product data online, compare internal product data to that found at point-of-sale, to correct existing data and enter new product information, and to deliver the data to retailer systems electronically via product data distributors. Manufacturers of couponed products, retailers, advertising agencies, printing companies, and clearinghouses are primary system users.

FIGS. 1 through 5 illustrate the parsing procedure of the scanned barcode. Not all errors trigger termination of the analysis to cause a failure report. FIG. 1 depicts a standard computer scanning a barcode data strip and transmitting the scanned data to an Internet web site having a coupon verification system, using a standard browser. The Internet based system checks the first digits to determine whether it is a coupon barcode. If it is not, a failure report is generated immediately. The system next checks for the check digit, then verifies the EAN-128 extended code to determine that it is present and if so, whether it matches one of five accepted formats. If one of two of the five EAN-128 formats that contains an expiration date is used, the system determines the expiration date of a coupon and its redemption period. A validation of the UCC Company Prefix (MIN) is performed. This validation is carried out in four steps, to determine (i) whether the MIN is valid, (ii) whether the MIN is registered with the UCC, (iii) whether the MIN used is associated with the user account, and (iv) whether the manufacturer has product data associated with the MIN in current published retailer POS data. Next the program verifies the family code. This task is accomplished during several sequential steps, including (i) use of standard universal family code, (ii) use of summary family code, (iii) use of family code with no super summary code, (iv) use of family code with no summary code, (v) use of super summary code, and (vi) use of 992 family bypass code. The system then builds a valid product list from current POS data based on the family code and UCC company prefix (MIN). Thereafter, the system identifies products with unregistered family codes and products with transition family codes using the process described above. A search is then carried out to locate a description for the family code within data supplied by the manufacturer. The system then validates the value code and 992 bypass family code usage, and looks at histories for identical scans on file and of identical offers on file. These procedures result in a coupon validation report containing details describing each of the preceding steps if the coupon is determined to be readable by POS systems, or a failure report describing which element caused failure of the coupon barcode structure if the coupon barcode is determined not to be readable by POS systems.

The web site immediately displays the results of the barcode scan to provide either a validation report or a failure report as described above. The system also stores the coupon image when submitted by the user, which is provided as a printable attachment to either the verification report or the failure report for documentation purposes.

Referring to FIGS. 1-5 of the drawings, there is shown the method and apparatus of the present invention. FIG. 1 is a block diagram illustrating the functional components of CouponChek™ Barcode Verification system. The system functions by contacting the www.couponchek.com web site using an Internet connection. This can be accomplished by using a PC with modem or DSL or other high-speed links to the Internet. Computer requirements for this purpose comprise a barcode scanner to read the barcode data, and a web browser program.

Barcode data is first scanned via the browser, which transmits the data to the web site. The logic pipeline ‘A’ feeds the barcode data into a functional logic element marked block B to analyze the barcode. The results of the analysis are output through logic pipeline ‘J’ into two sets of outcomes. If the barcode passes the tests, it is sent to print an acceptance certificate. The notices and warnings elements in the coupon are displayed, and can be printed using the computer at the coupon scanning location. A list of valid products can be displayed and printed. An electronic image of the acceptable coupon can be uploaded so that other users may view the graphics of the coupon. Using a computer keyboard, the operator can input other offer details. The operator can enter approval information for an acceptance certificate to concur with its result. This provides an auditable coupon acceptance certificate, which is completely documented with authorization name and signature. If the coupon barcode fails the logic elements of block B, a coupon failure report is produced. A failure report provides error descriptions and solutions needed to eliminate the error. An electronic image of the failed coupon can be uploaded so that other users may view the graphics of the coupon.

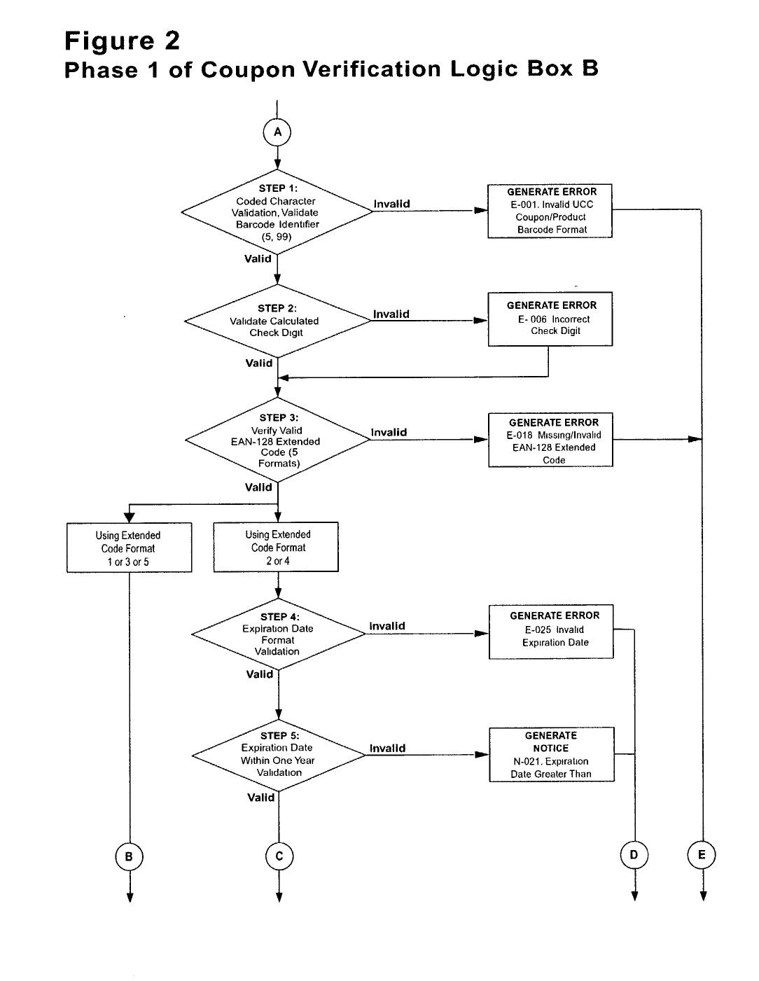

In FIG. 2 there is shown a block diagram illustrating the functional components of the coupon checking logic block B of FIG. 1, called phase 1 of coupon verification logic. The coupon barcode is first checked in step 1 for first digits 5 or 99, which indicates that it is indeed a coupon according to UCC guidelines. If the first digit(s) are not 5 or 99, it is not a valid coupon and the checking logic sequence is diverted along logic pipeline ‘E’. Next, in step 2, there is verified a check digit, which is a value derived from other digits of the barcode reduced to one number through algebraic calculation. If the check digit is wrong, the barcode will not be readable at point-of-sale. Next, in step 3, the presence of a valid EAN-128 code is checked. This code may be printed in one of five formats. If there is no EAN-128 code present, or it does not follow one of the five formats, the barcode does not follow UCC guidelines and the checking logic sequence is diverted along logic pipeline ‘E’. If one of the five valid EAN-128 codes is present, its format will determine the logical treatments. If the EAN-128 code is in format 2 or 4, the expiration date code format is checked in step 4. If the expiration date format does not follow UCC guidelines, the checking logic sequence is diverted along logic pipeline ‘D’. If the expiration date format is valid but is greater than one year from the scan date, the system generates a notice, which is noted in step 5, and proceeds along logic pipeline ‘D’. If the expiration date is not more than one year from the scan date, the checking process continues along logic pipeline ‘C’. EAN128 codes using format 1, 3, or 5 are treated further along logic pipeline ‘B’.

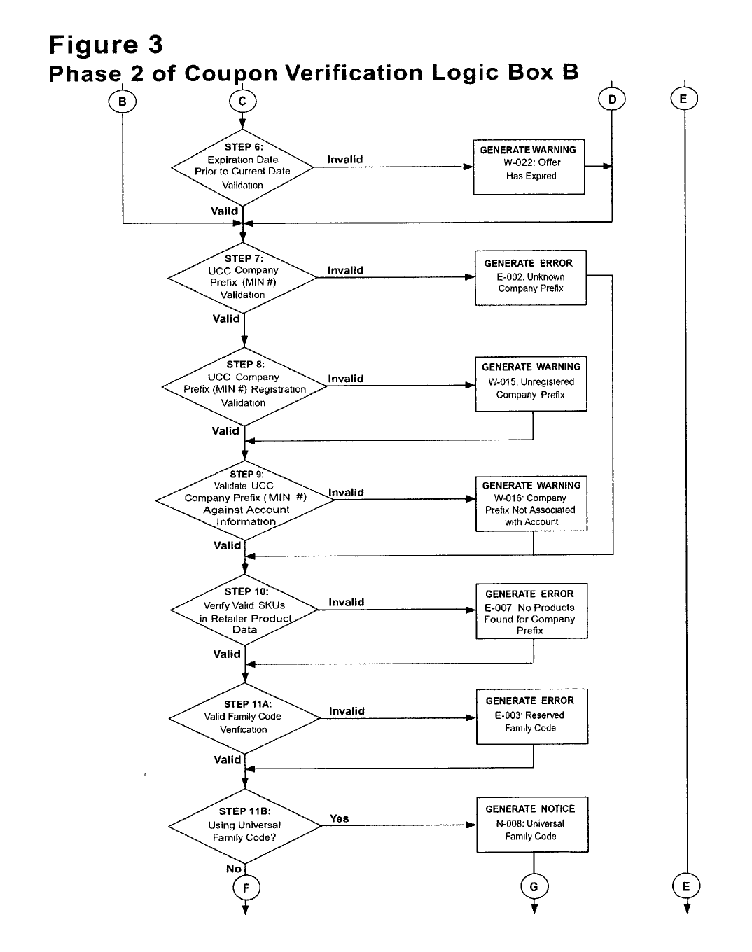

In FIG. 3 there is shown a block diagram illustrating the functional components of the coupon checking logic block B in FIG. 1, called phase 2 of coupon verification logic. The logic pipelines ‘B’, ‘C’, ‘D’ and ‘E’ from FIG. 2 are continued in FIG. 3. Logic path ‘C’ of the barcode verification process compares the coded expiration date against the current date in step 6. If the coded expiration date is earlier than the current date, the system generates a warning that the coupon has expired, diverting the logic path to ‘D’. Logic paths ‘B’, ‘C’ and ‘D’ are rejoined in logic path ‘C’ after step 6. The UCC Company Prefix (MIN) is validated against current UCC manufacturer data in step 7. If the coupon MIN is not found in the UCC manufacturer data, an error is generated signaling this condition and the checking logic is continued. If the coupon MIN is found in UCC manufacturer data, step 8 checks the UCC manufacturer information to determine if the MIN is registered with the UCC. If the coupon MIN is not registered with the UCC a warning is generated. Next, in step 9, the coupon MIN is checked against the system list of MINs associated with the user's account. A warning is generated if the coupon uses a MIN that is not associated with the user's account. Next, in step 10, the current POS product data is checked for the existence of products belonging to the MIN being used and a error is generated if none are found. Next, in step 11A, the family code of the barcode is checked to see if it is one reserved per UCC guidelines; if so, an error is generated. In step 11B, the family code is checked to see if it is the universal code per UCC guidelines; if so, a notice is generated. Phase 2 exits with logic pipes ‘F’, ‘G’ and ‘E’.

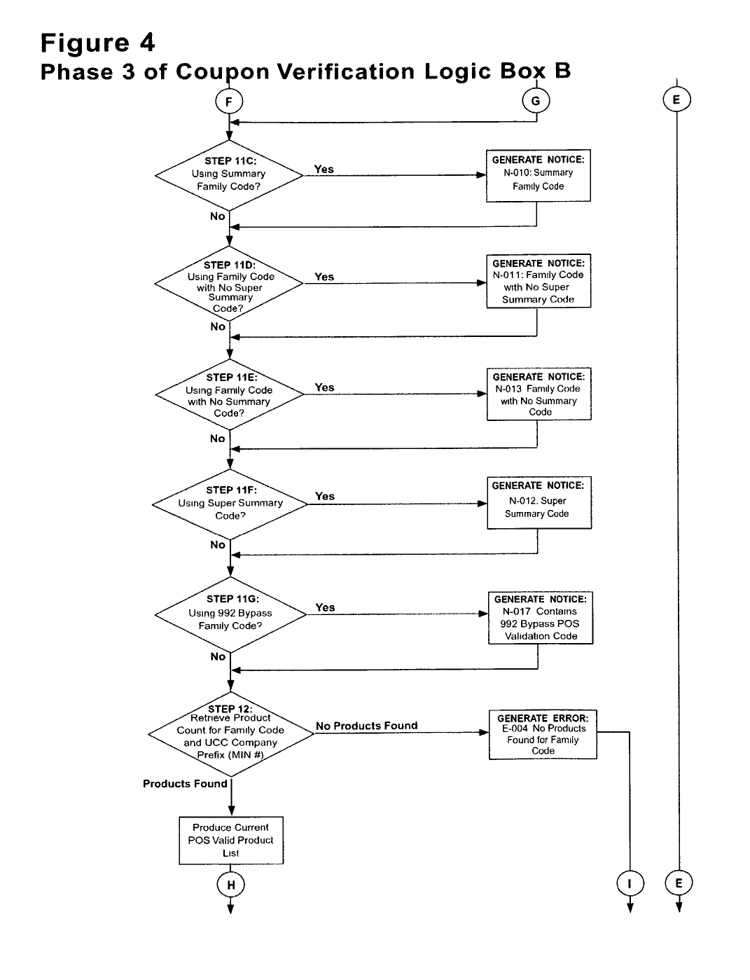

FIG. 4 is a block diagram illustrating the functional components of the coupon checking logic block B in FIG. 1, called phase 3 of coupon verification logic. The logic pipelines ‘F’, ‘G’ and ‘E’ from FIG. 3 are continued in this figure. Logic paths ‘F’ and ‘G’ of barcode verification are checked in step 11C to determine if the family code used is a Summary Code; if so, a notice is generated. Next, in step 1 ID, the system checks to determine whether the family code used has a Super Summary Code. If the family code does not have a Super Summary Code, a notice is generated indicating this condition. Next, in step 11E, the system checks to determine whether the family code used has a Summary Code. If the family code does not have a Summary Code, a notice is generated. In step 11F, the family code is checked to determine whether it is a Super Summary Code; if so, a notice is generated. Next, in step 11G, the system determines whether 992 Bypass Family Code is being used. If the 992 Bypass Family Code is detected, a notice is generated to indicate that 992 Bypass Code is present. Next, in step 12, the product count and list for the Family Code and UCC Company Prefix (MIN) is retrieved from the database. If no products are found, an error is generated indicating that no products were found for the Family Code and MIN and the logic pipeline follows along path ‘I’. If at least one product match is found, the logic pipeline follows along pipeline ‘H’. The logic pipelines continue along ‘H’, ‘I’ and “E”.

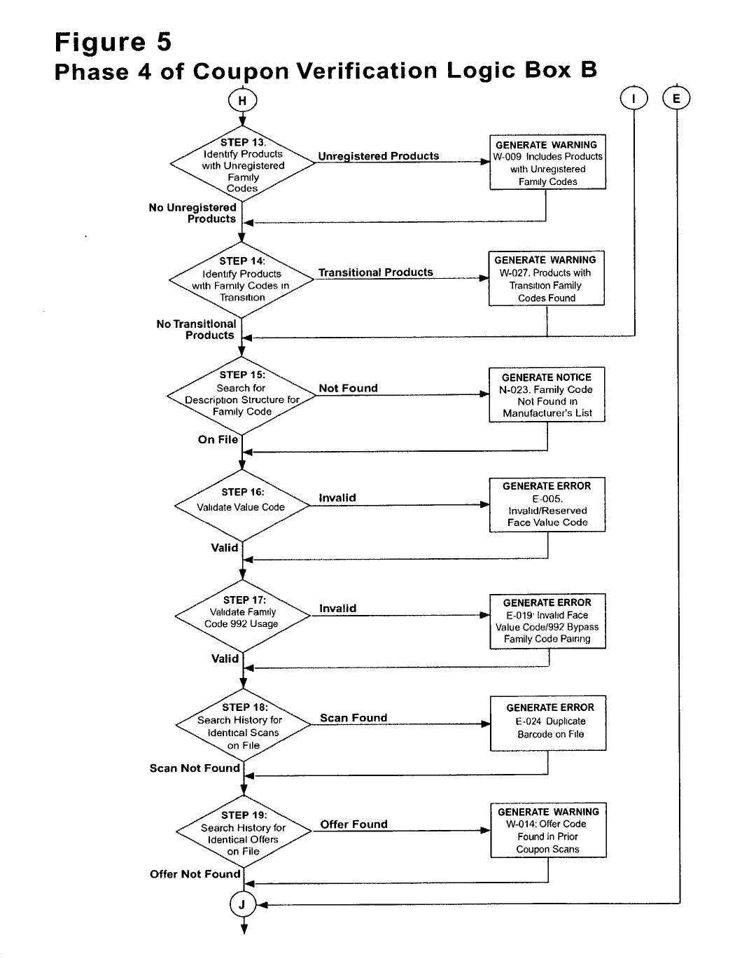

FIG. 5 is a block diagram illustrating the functional components of the coupon checking logic block B of FIG. 1, called phase 4 of coupon verification logic. The logic pipelines ‘H’, ‘I’ and ‘E’ from FIG. 4 are continued. Logic path ‘H’ identifies products with unregistered family codes in step 13. If unregistered products are found, a warning is issued. Next products that have family codes in a transition state are identified in step 14. Logic path ‘I’ joins logic path ‘H’ in step 15, where the system searches family code data provided by the manufacturer for a description of the family code used. If no match is found to the barcode data, a general notice is issued indicating no description is available for the family code begin used on the coupon. In step 16 the validity of the value code is determined. If the coupon value code is invalid, an error is generated. Step 17 compares the Family Code 992 usage against UCC guidelines. If the use of 992 Bypass Family Code is incorrect, an error is generated. Step 18 searches the history of stored data to look for identical scans on file. If a matching scan is found, an error is generated, indicating that a duplicate barcode is already on file. Step 19 searches history for identical offer codes on file. If the offer code is found, a warning is generated to indicate that the offer code has been used in prior scans. Upon completing the logic verification of block B in FIG. 1, the system check exits as logic pipeline ‘J’, printing a coupon acceptance report or a coupon failure report, as shown in FIG. 1.

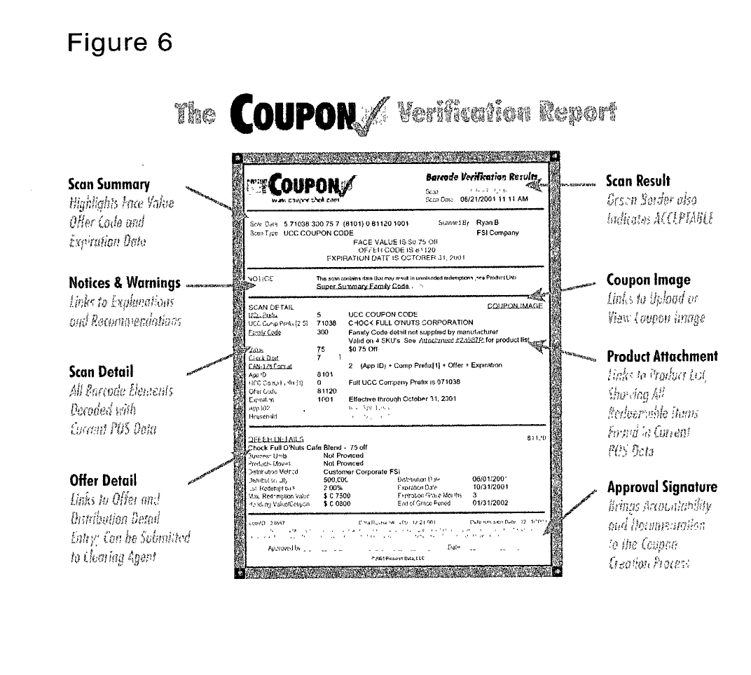

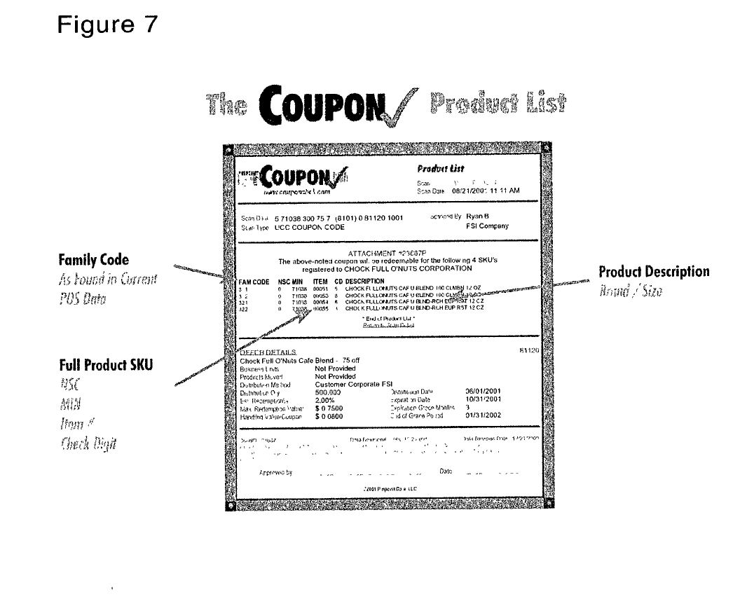

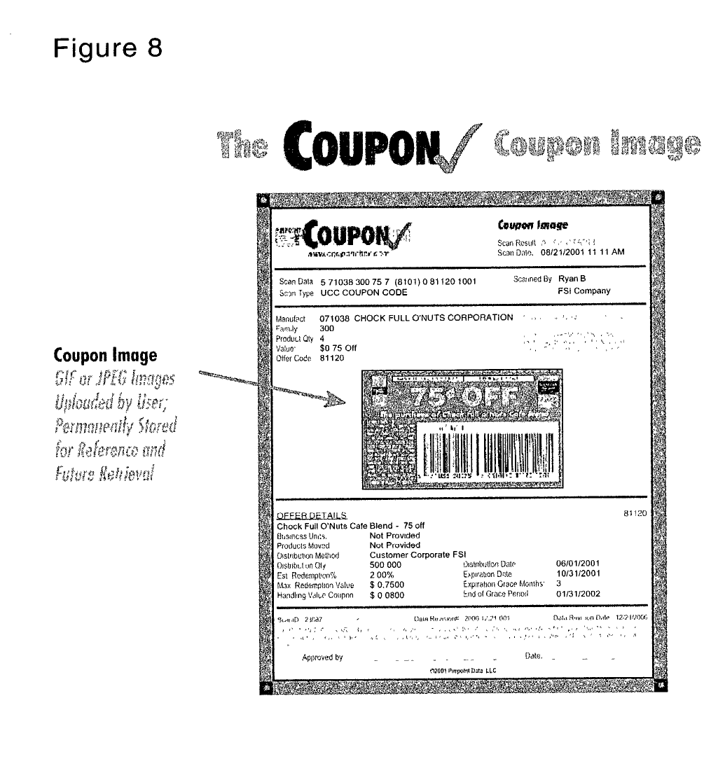

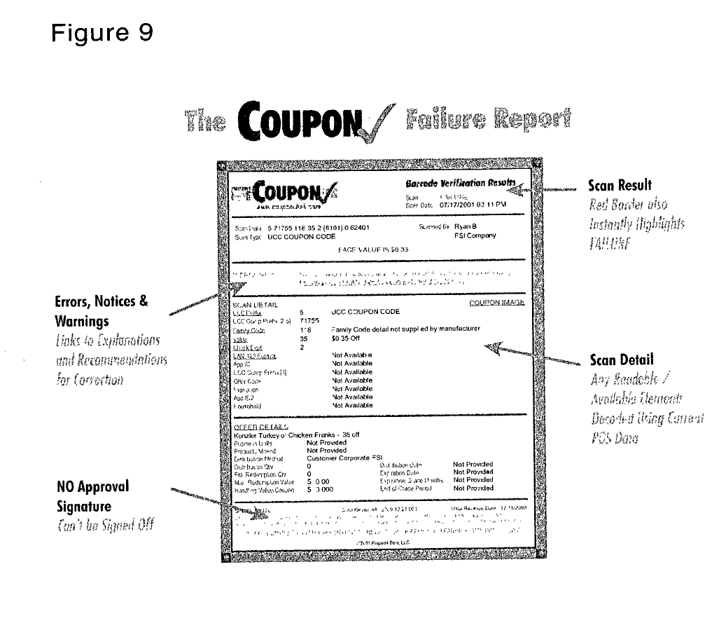

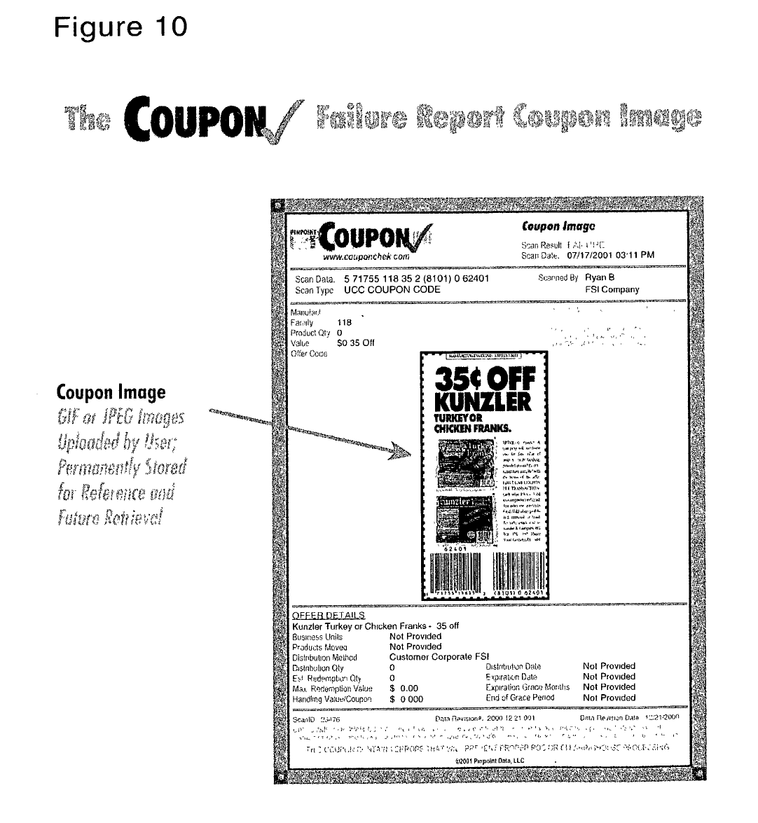

In FIGS. 6 through 10 there are shown various outputs generated by the coupon verification system. Each of these outputs has been identified in FIGS. 1 through 5. FIG. 6 is a printout of a Coupon Verification Report explaining details of each of the elements in the report indicating how the coupon will be decoded at POS. This verification report can be countersigned by the approving manager to create an audit report. Manufacturers or their agents contact the www.couponcheck.com website to create the coupon verification report and review it to ensure that the coupon contains the intended offer data. FIG. 7 is a sample Coupon Product List generated by the system showing all products that will be accepted for the coupon's redemption validate according to current POS retail product data. The coupon barcode must have no barcode errors in order for the system to produce the valid Product List. As indicated by FIG. 1, an electronic image of the coupon may be submitted to the www.couponcheck.com website and associated with a given barcode scan. FIG. 8 is a ample Coupon Image document generated by the system, indicating the graphics of the coupon along with a description of the barcode elements. When a new coupon is created and is yet to be issued, the coupon verification system at www.couponcheck.com can verify the accuracy of the barcode of the coupon and store the graphics of the coupon within its database. Authorized users with an Internet connection can access the www.couponchek.com website to view image and content of coupons that are to be issued to the public through various distribution methods. This procedure is particularly advantageous for coupon clearinghouses, since it provides a preview of upcoming coupons, and facilitates the organization of collection and sorting operations when large numbers of coupons are processed for redemption. FIG. 9 is a printout of a Coupon Failure Report generated by the system. The report indicates the reasons for failure of the barcode to pass verification tests, and suggests methods to fix the errors. A failure report cannot be countersigned with an approval signature, since the coupon is defective. FIG. 10 is a sample Coupon Image document associated with a failed barcode, wherein the verification test generates errors or warnings. An itemized list of all errors, warnings, and notices produced by the system and suggested remedies where applicable is set forth hereinafter in Table I.

TABLE I
CouponChek Exception List
CouponChek ERRORS
A barcode generating one of the following scan Errors will not process correctly at POS, if
at all. Most retailers fine manufacturers for coupons that cannot be processed by their POS
systems, as they interfere with front-end processing and can cause redemption problems.
One or more Errors detected by CouponChek will cause a Scan Result of FAILURE. A
Failure may or may not also contain Warnings or Notes.

| | |
|---|---|
| 001 | Invalid UCC Coupon/Product Barcode Format |
| | DESCRIPTION: The data is not in a standard UCC product or coupon format. It may |
| | include unreadable, invalid, missing or extra characters that prevent it from matching a |
| | standard UCC data format. POS systems can only interpret data in the accepted |
| | formats, and will reject coupons that cannot be read, which results in retailer fines. |
| | RECOMMENDATION: Compare the Scanned Data to the human-readable portion of |
| | the barcode. If they differ, the barcode may be incorrect. If not, the overall format is |
| | incorrect; see Pinpoint's “About Barcode Verification” for information on barcode |
| | formats and content. |
| 002 | Unknown Company Prefix (MIN) |
| | DESCRIPTION: The full six-digit Company Prefix contained in the scan was not |
| | found in the current UC Council Membership of Company Prefixes. Digits 2-6 of the |
| | MIN are found in the first barcode (the UCC Coupon Code), and the first digit (NSC) |
| | is found in the second barcode (the EAN-128 Extended Code). Often, the problem |
| | occurs when a manufacturer uses an incorrect first digit (located in the Extended |
| | Code). |
| | When a coupon's Company Prefix is incorrect, POS systems may not be able to find |
| | products for the manufacturer when validating the purchase, and may reject the |
| | coupon. |
| | RECOMMENDATION: Verify that the complete Company Prefix is correct. If you |
| | believe the Company Prefix is correct, contact the UC Council at (937) 435-3870 to |
| | resolve the issue. |
| 003 | Reserved Family Code |
| | DESCRIPTION: The Family Code contained in the scan is not available for |
| | manufacturers' use, as specified in the latest UC Council Coupon Guidelines |
| | Publication. Currently reserved Family Codes are 001, 002, 003, 004, 005, 006, 007, |
| | 008, 009, 990, 991, 993, 994, 995, 996, 997, 998 and 999. The UCC may opt to |
| | implement special functions (e.g., the ‘992’ bypass code) for any of these codes at any |
| | time. As such, manufacturers are instructed to not use these codes in family code |
| | structures. |
| | RECOMMENDATION. The Family Code should be changed to one that is not on |
| | Reserved status. The manufacturer's Family Code structure may need to be revised. |
| | See Pinpoint's About Family Codes for additional information. |
| 004 | No Products Found For Family Code |
| | DESCRIPTION: The Family Code contained in the scan was not found in any of the |
| | manufacturer's product records distributed to retailers. It will not match any of the |
| | manufacturer's products at POS, and will cause any Family Code-level validation to |
| | fail. |
| | Often this can occur with new product releases: if the coupon is for a new item, the |
| | item's Family Code data may not have been communicated yet to Let's Go |
| | Shopping/IRI. |
| | In other instances, the coupon has been coded with an incorrect family code. |
| | RECOMMENDATION: Check that product data distributors (LGS/IRI) have been |
| | provided the most recent product data, or review existing product data to find the |
| | correct Family Code. |
| 005 | Invalid/Reserved Face Value Code |
| | DESCRIPTION: The Face Value Code contained in the scan is not available for |
| | manufacturers' use at this time, as specified in the UC Council Coupon Guidelines |
| | Publication. It cannot be processed by POS systems. Valid codes are 2 digits, from 00- |
| | 99. Of these, 17, 24, 94 and 97 are reserved by the UCC. |
| | RECOMMENDATION: The Face Value Code should be changed to one that is not on |
| | Reserved status. See Pinpoint's About Face Value Codes for additional information. |
| 006 | Incorrect Check Digit |
| | DESCRIPTION: The Check Digit contained in the scan is not the correct value, based |
| | on the calculation found in the UC Council Coupon Guidelines. It will not be |
| | processed at POS. |
| | RECOMMEDATION: Consult Pinpoint's About Check Digits to determine the correct |
| | check digit for your barcode. |
| 007 | No Products Found For Company Prefix |
| | DESCRIPTION: The Company Prefix contained in the scan was not found in any of |
| | the product records published by your product data distributor. It will not match any |
| | manufacturer/product combinations currently on file, and POS Manufacturer-level |
| | validation will fail. |
| | Often this error will appear in conjunction with 002-Unknown Company Prefix. When |
| | a correct Company Prefix is used, the 007-No Products Found for Company Prefix will |
| | likely be addressed as well. |
| | RECOMMENDATION: Check that the product data distributors (IRI/LGS) have been |
| | provided the manufacturer's most recent product data, or verify the manufacturer's |
| | Company Prefix assignments. |
| 018 | Missing/Invalid EAN-128 Coupon Extended Code |
| | DESCRIPTION: The coupon data scanned does not contain the EAN-128 Coupon |
| | Extended Code implemented by the UCC in 1997, or the Extended Code is not in one |
| | of the five formats readable by POS systems. |
| | Although many POS systems still do not process the data contained in the Extended |
| | Code, many retailers fine manufacturers who do not include this second barcode on |
| | coupons. |
| | RECOMMENDATION: Per the UCC, all coupons must include an EAN-128 Coupon |
| | Extended Code, and it must be in one of the five accepted formats. See Pinpoint Data's |
| | ‘About UCC/EAN-128’ for details regarding the five formats. |
| 019 | Invalid Face Value Code/992 Bypass Family Code Pairing |
| | DESCRIPTION: The Face Value code found on the scan cannot be combined with |
| | Family Code 992 per UCC Guidelines. These Face Values require automated |
| | validation or checker verification, which is skipped for Family Code 992. |
| | A common example is combining the 992 Family Code with a Value Code that |
| | includes a multiple purchase requirement, such as 42-“Buy 3 or More, Get $1.00 Off”. |
| | When the POS system encounters the 992 Family Code, it goes directly to the Value |
| | Code without verifying that the order contains items for that manufacturer or |
| | manufacturer/family code. However, value code 42 requires that the POS system |
| | verify a purchase quantity, conflicting with the previous instruction. |
| | RECOMMENDATION: The intended offer should be reviewed and modified, or the |
| | barcode should be corrected. If the 992 bypass code cannot be avoided, and the offer |
| | includes a multiple purchase, the single-purchase equivalent value code should be used |
| | instead, as it will not cause processing problems at POS. (Multiple quantity value |
| | codes will not validate anyway, and may not process at all.) |
| 025 | Invalid Expiration Date |
| | DESCRIPTION: The Expiration Date (contained in UCC/EAN-128 Extended Code |
| | formats 2 and 4) must be in MMYY format, where MM is a month indicated as 01-12 |
| | and YY is the last 2 digits of the four-digit year (‘00’ = 2000). Invalid date formats |
| | (e.g., month = ‘15’) cannot be processed at POS. |
| | RECOMMENDATION: The barcode data must be corrected. |

CouponChek WARNINGS
A barcode generating one of the following scan Warnings contains data with the potential to
delay or prevent POS or Clearinghouse processing, and may result in Retailer or
Clearinghouse charges.
Warnings do not prevent POS processing, and thus will result in a Scan Result of
Acceptable. (Provided that no Errors are also present.) However, the user should carefully
review the Warnings to ensure that any problems leading to fines, fees or unintended
redemptions are addressed.

| | |
|---|---|
| 009 | Includes Products with Unregistered Family Codes |
| | DESCRIPTION: Family codes are assigned to products by manufacturers, who group |
| | “like” products within families for the purpose of couponing. The manufacturers must |
| | distribute these assignments to retailers, usually via distributors such as IRI and Let's |
| | Go Shopping. When retailers or distributors encounter items without Family Code |
| | assignments, they may assign their own “best guess” for the item's Family Code when |
| | no information from the manufacturer is available. As a result, the item may or may |
| | not have the manufacturer's intended Family Code designation in POS data. This |
| | could result in redemptions that the manufacturer did not intend. The CouponChek |
| | Product List indicates these items with *. |
| | RECOMMENDATION: Review the Product List that accompanies the CouponChek |
| | certificate. Contact product data distributors to have the Family Code assignments |
| | corrected, if necessary. |
| 014 | Offer Code Found In Prior Coupon Scans |
| | DESCRIPTION: The Offer Code found in the scan has been used in other coupon |
| | barcode(s) for this manufacturer. This may cause incorrect redemption tracking. In |
| | addition, clearinghouses often assess fees for handling duplicate barcodes. |
| | RECOMMENDATION: Review the Offer Code list and determine if the Offer Code is |
| | being incorrectly duplicated. Change Offer Code if necessary. |
| 015 | Unregistered Company Prefix |
| | DESCRIPTION: The 6-Digit Company Prefix found in the scan is not in the UC |
| | Council's published data. It is most likely the result of an error by the manufacturer in |
| | translating National Drug Codes (NDC) or National Health-Related Item Codes |
| | (NHRIC) into coupon Company Prefixes. A common cause of this error is an incorrect |
| | first digit, found in the extended code. This may interfere with the POS systems' |
| | ability to match items to the Company Prefix used on the coupon. |
| | RECOMMENDATION: Correct the coupon data, or contact the UC Council |
| | immediately to register the Company Prefix being used. |
| 016 | Company Prefix Not Associated with Account |
| | DESCRIPTION: The Company Prefix (MIN) found in the scan is not on included on |
| | your CouponChek account's MIN list. This may mean that a MIN other than one |
| | belonging to your company was used on the coupon, which will result in validation |
| | failure, retailer fines, and clearinghouse charges. |
| | RECOMMENDATION: Verify the Company Prefix used on the coupon. If you believe |
| | the code to be correct, and would like to have the Company Prefix added to your list, |
| | contact Pinpoint Data. If you are scanning a coupon unrelated to your manufacturer |
| | list, you may disregard this message. |
| 022 | Offer Has Expired |
| | DESCRIPTION: The coupon scanned contains an expiration date that has passed as of |
| | today (the scan date.) |
| | RECOMMENDATION: Verify the intended offer expiration date, and correct the |
| | barcode. |
| 024 | Duplicate Barcode on File |
| | DESCRIPTION: This barcode has already been scanned into CouponChek. If the |
| | barcode is being re-used on a different offer, retailer fines and clearinghouse charges |
| | can result, especially if an offer code is included. |
| | RECOMMENDATION: If you believe this to be a first-time scan, you should verify |
| | that the barcode is original to this coupon, and then investigate all previous scans by |
| | using the Scan History Report. |
| 027 | Products with Transition Family Codes |
| | DESCRIPTION: Your product data distributor records contain products that are being |
| | transitioned from the alternate family code to the mfg family code. Products in |
| | transition will be valid under either family code at POS. |
| | RECOMMENDATION. Verify all products on the attachment are intended to be |
| | included in the offer and contact your product data distributor with any needed |
| | corrections. |

CouponChek NOTES
A barcode generating one of the following scan Notes contains data that may result in
unintended redemptions.
Notes do not interfere with POS processing, and thus will result in a Scan Result of
Acceptable (provided that no Errors are also present.) However, the offer and the barcode
components should be carefully reviewed to ensure the most appropriate coding is used.

| | |
|---|---|
| 008 | Universal Family Code 000 |
| | DESCRIPTION: The Family Code in the scan, 000, is the ‘Universal’ code. It will |
| | allow the coupon to be used on any/all products registered to this manufacturer (items |
| | with the same MIN as the coupon), regardless of the human-readable component of the |
| | coupon. |
| | RECOMMENDATION: Verify that all of the products on the attachment are intended |
| | to be included in the offer. If possible, use a more specific Super Summary, Summary |
| | or Family Code to limit unintended redemptions. |
| 012 | Super Summary Family Code |
| | DESCRIPTION: The Family Code found in the scan is a ‘Super Summary’ code |
| | (ending in 00.) It will allow the coupon to be used on a range of the manufacturer's |
| | Family Codes and multiple product codes, regardless of the human-readable |
| | component of the coupon. |
| | RECOMMENDATION: Verify that all of the products on the attachment are intended |
| | to be included in the offer. If possible, use a more specific Summary or Family Code |
| | to limit unintended redemptions. |
| 010 | Summary Family Code |
| | DESCRIPTION: The Family Code found in the scan is a ‘Summary’ code (ending in 0, |
| | but not 00.) It will allow the coupon to be used on a range of the manufacturer's |
| | Family Codes (and multiple product codes), regardless of the human-readable |
| | component of the coupon. |
| | RECOMMENDATION: Verify that all of the products on the attachment are intended |
| | to be included in the offer. If possible, use a more specific Family Code to limit |
| | unintended redemptions. |
| 011 | Family Code Has No Super Summary Code |
| | DESCRIPTION: The Family Code found in the scan does not have a Super Summary |
| | Code. The UCC recommends that Family Codes do not begin with ‘0’, as there can be |
| | no Super Summary Code for those families. |
| | RECOMMENDATION: This will not affect POS processing, but the manufacturer's |
| | Family Coding scheme should be reviewed to ensure maximum effectiveness and |
| | flexibility. |
| 013 | Family Code Has No Summary Code |
| | DESCRIPTION: The Family Code found in the scan does not have a Summary Code. |
| | The UCC recommends that Family Codes do not contain ‘0’ in the middle position, as |
| | there can be no Summary Code for those families. |
| | RECOMMENDATION: This will not affect POS processing, but the manufacturer's |
| | Family Coding scheme should be reviewed to ensure maximum effectiveness and |
| | flexibility. |
| 017 | Contains 992 Bypass POS Validation Family Code |
| | DESCRIPTION: The Family Code found in the scan, 992, is the UCC's ‘Bypass POS |
| | Validation’ code. It permits non-validated scanning for random-weight products, |
| | products of a merged/acquired company, tie-in offer couponed products, or in-ad |
| | coupons paid for by the retailer. Because it omits an important validation and control |
| | feature, the UCC strongly cautions manufacturers in the use of the code. |
| | The 992 bypass code should never be used for multi-purchase requirements or free |
| | offers. |
| | RECOMMENDATION: Verify the necessity in using the 992 code. |
| 020 | Extended Code does not Contain/Match Entered Expiration Date |
| | DESCRIPTION: The user has entered an Expiration Date for scan verification, but the |
| | EAN-128 does not contain an expiration date, OR the date stored in the scan does not |
| | match the entry. |
| | RECOMMENDATION: Only EAN-128 formats 2 and 4 contain expiration dates. |
| | Verify both the entered date, the scan data and/or the EAN-128 format in use. |
| 021 | Expiration Date Greater Than 1 Year |
| | DESCRIPTION: The coupon scanned has an expiration date of more than one year in |
| | the future. |
| | RECOMMENDATION: Verify the intended offer expiration date. |
| 023 | Family Code Not Found In Manufacturer's List |
| | DESCRIPTION: This note only applies to CouponChek's manufacturing clients who |
| | subscribe to Pinpoint's Family Code Manager service. It indicates that the Family |
| | Code used on the offer was not found on the list of valid Family Codes provided to |
| | Pinpoint Data by the manufacturer. |
| | RECOMMENDATION: The Family Code used on the coupon should be verified with |
| | the manufacturer. If valid, the Family Code data stored at Pinpoint Data should be |
| | updated, via the Pinpoint Data website, by an authorized manufacturer representative. |

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An Internet-based Coupon Barcode Verification system, comprising:
a. a central computer system connected to the Internet and adapted to be accessed by one or more authorized personal computers having minimal hardware and software requirements, which include a PC with Internet access, a web browser program, and optionally, a barcode reader to input the contents of barcode data;
b. said central computer system having algorithm logic means for analyzing the barcode data from such authorized personal computers to determine the validity of the barcode data according to UCC guidelines and recognized MIN, Family Codes, Value Codes, Check Digits, and EAN-128 Extended Codes;
c. said central computer system having an actively managed database comprising barcode data and coupon images for accepting and delivering data and images to one or more authorized personal computer users connected over the Internet;
d. an operating system;
e. a database management system;
f. a database of combined public and private data sources including Manufacturer MIN numbers, value codes, and retail point of sale product and family code data; and
g. said system having a high bandwidth connection to the Internet.

2. A coupon barcode verification system as recited by claim 1, configured to interface with authorized personal computer users via the Internet, which input the barcode data using a keyboard,

3. A coupon barcode verification system as recited by claim 1, configured to interface with authorized personal computer users via the Internet, which input the barcode data using a barcode reader,

4. A coupon barcode verification system as recited by claim 1, configured to interface with authorized personal computer users via the Internet, which input the graphics of the coupon for specific barcode data.

5. A coupon barcode verification system as recited by claim 1, having algorithm logic means for determining whether a barcode is a coupon or not, using the first digit of the barcode.

6. A coupon barcode verification system as recited by claim 1, having algorithm logic means for validating the check digit of the coupon barcode data.

7. A coupon barcode verification system as recited by claim 1, having algorithm logic means for verifying valid EAN-128 code, recognizing five formats and validating expiration date code format.

8. A coupon barcode verification system as recited by claim 1, having algorithm logic means for verifying a valid UCC company prefix, validation of registration of the MIN#, company account information and company product and family code data.

9. A coupon barcode verification system as recited by claim 1, having algorithm logic to verify a valid Family Code and recognize whether Universal Family Code, Reserved Family Code, Summary Family Code, Super Summary Code, or 992 Bypass Family Code is used.

10. A coupon barcode verification system as recited by claim 1, having algorithm logic means for using a Family Code to determine whether POS product data is available for the MIN and family code being used and has been registered with various Retail data sources,

11. A coupon barcode verification system as recited by claim 1, having algorithm logic means for identifying coupon errors and generating a coupon acceptance verification report, which can be signed for audit purposes

12. A coupon barcode verification system as recited by claim 1, having algorithm logic means for accepting coupon images from said authorized personal computer users connected to the coupon barcode verification system over the Internet and storing such images within the database.

13. A coupon barcode verification system as recited by claim 1, having algorithm logic means for identifying coupon errors and generating a coupon failure report.

14. A coupon barcode verification system as recited by claim 1, said system being adapted to be accessed by authorized manufacturers to verify the validity of a coupon prior to its issuance.

15. A coupon barcode verification system as recited by claim 1, said system being adapted to be accessed by an authorized coupon clearinghouse to view images or content of a coupon prior to issuance thereof.
